(19) United States
(12) Patent Application Publication
(10) Pub. No.: US 2026/0253968 A1
(43) Pub. Date: Aug. 27, 2026

(54) NONAQUEOUS ELECTROLYTE SECONDARY BATTERY AND METHOD FOR PRODUCING NONAQUEOUS ELECTROLYTE SECONDARY BATTERY

(71) Applicant: Panasonic Energy Co., Ltd., Moriguchi-shi, Osaka (JP)

(72) Inventors: Ryota Okimoto, Osaka (JP); Masayoshi Yoshida, Osaka (JP)

(73) Assignee: Panasonic Energy Co., Ltd., Moriguchi-shi, Osaka (JP)

(21) Appl. No.: 18/578,365

(22) PCT Filed: Jun. 23, 2022
(86) PCT No.: PCT/JP2022/025069

§ 371 Date: Jan. 11, 2024

(30) Foreign Application Priority Data
Jul. 19, 2021 (JP) 2021-118819

(51) Int. Cl. H01M 10/0587; H01M 50/107; H01M 50/152; H01M 50/533; H01M 50/536

(52) U.S. Cl. CPC H01M 10/0587; H01M 50/107; H01M 50/152; H01M 50/533; H01M 50/536

(57) ABSTRACT

This nonaqueous electrolyte secondary battery is provided with: an electrode body in which a first electrode and a second electrode are wound; a nonaqueous electrolyte; an exterior can; and a sealing body. The first electrode has a core, a mixture layer formed on at least part of the surface of the core, and an exposed section of the core provided on one end on one side of the electrode body in the winding-axis direction. The exposed section has: an easily deformable section formed along the winding-axis direction of the electrode body; and an end surface section formed by the exposed section being curved along the easily deformable section, said end surface section being disposed on one end surface in the winding of the electrode body. The end section is joined to a current collector and the current collector is connected to the exterior can or the sealing body.

### TECHNICAL FIELD

The present disclosure relates to a non-aqueous electrolyte secondary battery and a method for manufacturing a non-aqueous electrolyte secondary battery.

### BACKGROUND ART

A non-aqueous electrolyte secondary battery in which a band-shaped positive electrode and negative electrode are stacked and wound to form a wound electrode assembly, and the electrode assembly is housed in a bottomed-cylinder-shaped exterior can has been conventionally and widely used. Patent Literature 1 discloses art that, in order to increase current-collecting efficiency in a battery to reduce electric resistance, an end of a core of an electrode is protruded from an electrode assembly, a tip of the end is pressed to form a flat part, and the flat part and a current-collecting plate are bonded. Patent Literature 2 discloses improved art of Patent Literature 1 that insurability between the electrodes is improved while reducing occurrence of buckling during formation of the flat part by subjecting a base of the end of the core to insulative coating.

### CITATION LIST

### Patent Literature

PATENT LITERATURE 1: Japanese Unexamined Patent Application Publication No. 2000-294222
PATENT LITERATURE 2: Japanese Unexamined Patent Application Publication No. 2006-32112

### SUMMARY

### Technical Problem

However, it is difficult to form the flat part uniformly in an entirety of the end of the electrode by pressing the tip of the end of the electrode. The present inventors have made intensive investigation, and consequently found that, when a gap is generated between the flat parts adjacent to each other in a radial direction of the electrode assembly due to formation of an ununiform flat part and the like, laser-bonding between the flat part and the current-collecting plate may cause laser light to reach an inside of the electrode assembly to damage constituent members of the electrode assembly, such as a separator. The art disclosed in Patent Literature 1 and Patent Literature 2 does not consider the damage of the electrode assembly during the laser-bonding, and still has a room for improvement.

It is an object of the present disclosure to provide a non-aqueous electrolyte secondary battery in which damage of the electrode assembly is inhibited, and a method for manufacturing the same.

### Solution to Problem

A non-aqueous electrolyte secondary battery of an aspect of the present disclosure comprises: an electrode assembly in which a first electrode and a second electrode having polarities different from each other are wound via a separator; a non-aqueous electrolyte; a bottomed-cylinder-shaped exterior can housing the electrode assembly and the non-aqueous electrolyte; and a sealing assembly capping an opening of the exterior can. The first electrode has: a core; a mixture layer formed on at least a part of a surface of the core; and an exposed portion of the core provided on an end on one side in a winding axis direction of the electrode assembly, the exposed portion has an easily-deformable portion formed along a winding direction of the electrode assembly, on an end face on one side in the winding axis direction of the electrode assembly, an end face portion formed by bending the exposed portion along the easily-deformable portion is disposed, the end face portion is bonded to a current-collecting plate, and the current-collecting plate is connected to the exterior can or the sealing assembly.

A method for manufacturing a non-aqueous electrolyte secondary battery of an aspect of the present disclosure is a method for manufacturing a non-aqueous electrolyte secondary battery comprising: an electrode assembly in which a first electrode and a second electrode having polarities different from each other are wound via a separator; a non-aqueous electrolyte; a bottomed-cylinder-shaped exterior can housing the electrode assembly and the non-aqueous electrolyte; and a sealing assembly capping an opening of the exterior can. The first electrode has: a core; a mixture layer formed on at least a part of a surface of the core; and an exposed portion of the core provided on an end on one side in a winding axis direction of the electrode assembly, and when the first electrode and the second electrode are wound, the exposed portion is protruded from an end face on one side in a winding axis direction of the electrode assembly, the exposed portion is bent along an easily-deformable portion formed along a winding direction of the electrode assembly to dispose an end face portion formed by bending the exposed portion of the core, and the end face portion and a current-collecting plate are laser-bonded.

### Advantageous Effect of Invention

According to the non-aqueous electrolyte secondary battery of the present disclosure, damage of the electrode assembly may be inhibited.

### BRIEF DESCRIPTION OF DRAWING

FIG. 1 is an axial cross-sectional view of a non-aqueous electrolyte secondary battery of an example of an embodiment.

FIG. 2 is a perspective view of a wound electrode assembly comprised in a non-aqueous electrolyte secondary battery of an example of an embodiment.

FIG. 3 is a front view illustrating a negative electrode to constitute an electrode assembly in an unwound state in an example of an embodiment.

FIG. 4 is a cross-sectional view along the A-A line in FIG. 3.

FIG. 5 is a view corresponding to FIG. 4 in a negative electrode in an electrode assembly.

FIG. 6 is a view illustrating a step of forming an inclined end face portion by bending an exposed portion of a core in a method for manufacturing a non-aqueous electrolyte secondary battery of an example of an embodiment.

FIG. 7 is a front view illustrating a negative electrode to constitute an electrode assembly in an unwound state in another example of an embodiment.

FIG. 8 is a cross-sectional view along the B-B line in FIG. 7.

FIG. 9 is a view corresponding to FIG. 8 in a negative electrode in an electrode assembly.

FIG. 10A is a view illustrating an exposed portion of a core in a bent state along a second easily-deformable portion in a method for manufacturing a non-aqueous electrolyte secondary battery of another example of an embodiment.

FIG. 10B is a view illustrating a state where the exposed portion of the core is further bent from the state in FIG. 10A.

FIG. 10C is a view illustrating a state where the exposed portion of the core is further bent from the state in FIG. 10B to form a thick end face portion.

FIG. 10D is a view illustrating a state where the exposed portion of the core is bent along a first easily-deformable portion from the state in FIG. 10C to incline the end face portion.

FIG. 11 is a view corresponding to FIG. 9 in another example of an embodiment.

### DESCRIPTION OF EMBODIMENTS

Hereinafter, embodiments of a non-aqueous electrolyte secondary battery 10 according to the present disclosure will be described in detail with reference to the drawings. When the following description includes a plurality of embodiments, modified examples, and the like, it is anticipated in advance that characteristic parts thereof are appropriately combined to construct a new embodiment. Among constituent elements described hereinafter, constituent elements not described in the independent claim, which denotes the most generic concept, are optional constituent elements, and not essential constituent elements. In different embodiments, a same reference sign is used for a same constituent in the drawings, and an overlapped description is omitted. A plurality of the drawings includes schematic views, and between different drawings, ratios of size such as length, width, and height of each member do not necessarily coincide.

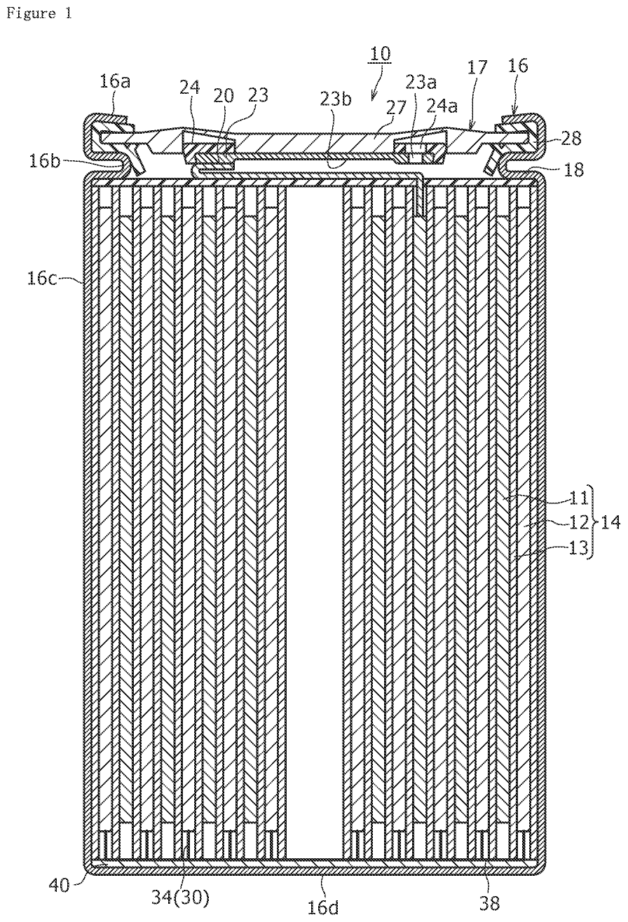

FIG. 1 is an axial cross-sectional view of the non-aqueous electrolyte secondary battery 10 of an example of an embodiment. As illustrated in FIG. 1, the secondary battery 10 comprises an electrode assembly 14, a non-aqueous electrolyte (not illustrated), a bottomed-cylinder-shaped exterior can 16 housing the electrode assembly 14 and the non-aqueous electrolyte, and a sealing assembly 17 capping an opening of the exterior can 16. The electrode assembly 14 includes a positive electrode 11 as an example of a first electrode, a negative electrode 12 as an example of a second electrode, and a separator 13 interposed between the positive electrode 11 and the negative electrode 12. As described later, the electrode assembly 14 has a wound structure in which the positive electrode 11 and the negative electrode 12 are wound via the separator 13. Hereinafter, for convenience of description, a direction along an axial direction of the exterior can 16 is described as “the vertical direction or the upper-lower direction”, a side of the sealing assembly 17 is described as “the upper side”, and a side of a bottom 16d of the exterior can 16 is described as “the lower side”. A winding axis direction of the electrode assembly 14 substantially coincides with the axial direction of the exterior can 16. A direction perpendicular to the axial direction of the exterior can 16 is described as “the horizontal direction or the radial direction”, a side of a center in the radial direction of the exterior can 16 is described as “the inner side”, and an outside in the radial direction is described as “the outer side”.

The non-aqueous electrolyte includes, for example, a non-aqueous solvent and an electrolyte salt dissolved in the non-aqueous solvent. As the non-aqueous solvent, carbonates, lactones, ethers, ketones, esters, and the like may be used, for example, and two or more of these solvents may be mixed for use. When two or more solvents are mixed for use, a mixed solvent including a cyclic carbonate and a chain carbonate is preferably used. For example, ethylene carbonate (EC), propylene carbonate (PC), butylene carbonate (BC), and the like may be used as the cyclic carbonate, and dimethyl carbonate (DMC), ethyl methyl carbonate (EMC), diethyl carbonate (DEC), and the like may be used as the chain carbonate. As the electrolyte salt, LiPF₆, LiBF₄, LiCF₃SO₃, and the like, and a mixture thereof may be used. An amount of the electrolyte salt dissolved in the non-aqueous solvent is, for example, greater than or equal to 0.5 mol/L and less than or equal to 2.0 mol/L.

The exterior can 16 is a bottomed-cylinder-shaped metallic container having an opening on one end (upper end) in the axial direction. The exterior can 16 has a shoulder portion 16a where an end of the opening is projected on the inner side in the radial direction, a grooved portion 16b where a side face is projected from the outer side to the inner side, a side wall 16c, and a disk-shaped bottom 16d.

On an end face on the lower side of the electrode assembly 14 housed in the exterior can 16, a negative electrode core exposed portion 34 in which a negative electrode core 30 is exposed is protruded from the negative electrode 12, and bent. In the negative electrode core exposed portion 34, an end face portion 38 disposed on the end face of the electrode assembly 14 is bonded to a current-collecting plate 40 disposed on the lower side of the electrode assembly 14, and the current-collecting plate 40 is connected to the bottom 16d to allow the exterior can 16 to be a negative electrode terminal.

An outer shape of the current-collecting plate 40 is not particularly limited, and for example, a disk having a diameter substantially same as an inner diameter of the exterior can 16. The current-collecting plate 40 may have a ventilation hole. A thickness of the current-collecting plate 40 is preferably greater than or equal to 0.1 mm and less than or equal to 0.7 mm, and more preferably greater than or equal to 0.3 mm and less than or equal to 0.5 mm. To substantially uniformly contact the current-collecting plate 40 with the end face portion 38 of the negative electrode core exposed portion 34, the thickness of the current-collecting plate 40 is preferably greater than or equal to 0.1 mm. When the thickness of the current-collecting plate 40 is less than or equal to 0.7 mm, the current-collecting plate 40 and the end face portion 38 may be bonded so as to have appropriate strength.

A material of the current-collecting plate 40 is not particularly limited as long as it has conductivity, but preferably a material same as the exterior can 16. According to this, the current-collecting plate 40 is easily connected to the exterior can 16 with welding. The material of the current-collecting plate 40 and the exterior can 16 is, for example, nickel-plated carbon steel.

The shoulder portion 16a of the exterior can 16 is formed when the end of the opening of the exterior can 16 is bent to caulk a peripheral portion of the sealing assembly 17. The sealing assembly 17 is fixed by caulking a gasket 28 between the shoulder portion 16a and the grooved portion 16b.

A space between the exterior can 16 and the sealing assembly 17 is enclosed with the gasket 28 being a cyclic member made of resin to seal an inside space of the secondary battery 10. The gasket 28 is sandwiched between the exterior can 16 and the sealing assembly 17 to insulate the sealing assembly 17 relative to the exterior can 16. That is, the gasket 28 has a role of a sealing material to retain airtightness inside the battery and a role as an insulative material to insulate the exterior can 16 and the sealing assembly 17.

The sealing assembly 17 is a disk-shaped member comprising a current cutting mechanism. The sealing assembly 17 has a structure in which a terminal plate 23, an insulating plate 24, and a rupture plate 27 are stacked in this order from the electrode assembly 14 side. A positive electrode lead 20 connected to the positive electrode 11 is passed through a through hole of an insulating plate 18, and connected to a lower face of the terminal plate 23, which is a bottom plate of the sealing assembly 17, with welding or the like. The rupture plate 27, which is a top plate of the sealing assembly 17 electrically connected to the terminal plate 23, becomes a positive electrode terminal. The terminal plate 23 has a ventilation hole 23a and a thin portion 23b to be removed if an internal pressure of the battery exceeds a predetermined threshold.

The rupture plate 27 is disposed opposite to the terminal plate 23 across the insulating plate 24. Formed in the insulating plate 24 are an opening to connect the terminal plate 23 and the rupture plate 27, and a ventilation hole 24a in a portion overlapped with the ventilation hole 23a of the terminal plate 23. The rupture plate 27 has a vent to be deformed to cut a current path if the internal pressure of the battery exceeds a predetermined threshold, and the vent is connected to a center of the terminal plate 23 via the opening of the insulating plate 24 with welding or the like. If the internal pressure of the battery further increases, the vent breaks to form a discharging port for gas. The insulating plate 24 insulates a portion other than the central connecting portion between the terminal plate 23 and the rupture plate 27.

In the example illustrated in FIG. 1, although the positive electrode lead 20 extends from the positive electrode 11 for connecting the positive electrode lead 20 to the sealing assembly 17, the connection is not limited to this example. For example, it is acceptable that the current-collecting plate is disposed on the upper side of the electrode assembly 14, a positive electrode core exposed portion provided on an end on one side in a width direction of the positive electrode 11 is bonded to the lower face of the current-collecting plate, and the positive electrode lead is extended from the upper face of the current-collecting plate to be connected to the sealing assembly 17. When the positive electrode core is bonded to the current-collecting plate as noted above, the negative electrode lead may be extended from the negative electrode 12 to connect the negative electrode lead to the exterior can 16.

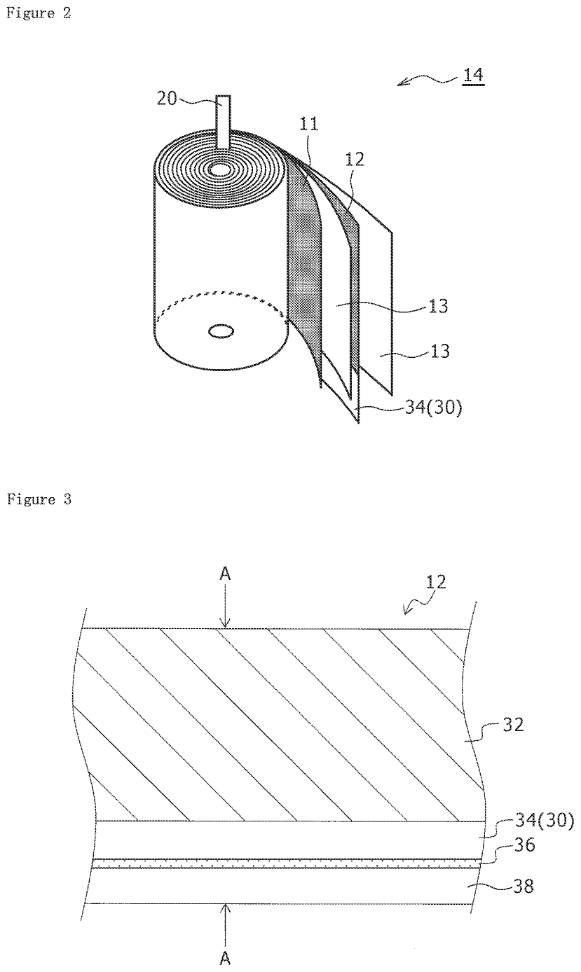

Next, the electrode assembly 14 will be described with reference to FIG. 2. FIG. 2 is a perspective view of the electrode assembly 14. As noted above, the electrode assembly 14 has the wound structure in which the positive electrode 11 and the negative electrode 12 are spirally wound via the separator 13. The positive electrode 11, the negative electrode 12, and the separator 13 are all formed in a band shape, and spirally wound around a winding core disposed along the winding axis to form an alternately stacked state in the radial direction of the electrode assembly 14.

The negative electrode 12 included in the electrode assembly 14 is typically formed to be larger than the positive electrode 11 in order to prevent precipitation of lithium on the negative electrode 12. Specifically, a length of the negative electrode 12 in the width direction is larger than a length of the positive electrode 11 in the width direction. A length of the negative electrode 12 in the longitudinal direction is larger than a length of the positive electrode 11 in the longitudinal direction. According to this, in the electrode assembly 14, at least a portion where a positive electrode mixture layer of the positive electrode 11 is formed is disposed opposite via the separator 13 to a portion where a negative electrode mixture layer of the negative electrode 12 is formed.

The positive electrode 11 has a positive electrode core and a positive electrode mixture layer formed on at least a part of a surface of the positive electrode core. The positive electrode mixture layer is formed on at least one of an inner peripheral side and an outer peripheral side of the positive electrode core, and preferably formed on an entire region of both surfaces of the positive electrode core except for a positive electrode core exposed portion, described later. For the positive electrode core, a foil of a metal such as aluminum, a film in which such a metal is disposed on a surface layer thereof, and the like are used, for example. A thickness of the positive electrode core is, for example, greater than or equal to 10 μm and less than or equal to 30 μm.

The positive electrode mixture layer includes, for example, a positive electrode active material, a conductive agent, and a binder. The positive electrode 11 may be produced by, for example, applying a positive electrode mixture slurry including the positive electrode active material, the conductive agent, the binder, and a solvent such as N-methyl-2-pyrrolidone (NMP) onto both surfaces of the positive electrode core, followed by drying and then rolling.

Examples of the positive electrode active material included in the positive electrode mixture layer include a lithium-transition metal oxide containing a transition metal element such as Co, Mn, and Ni. Examples of the lithium-transition metal oxide include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂MPO₄F (M represents at least one of the group consisting of Na, Mg, Sc, Y, Mn, Fe, Co, Ni, Cu, Zn, Al, Cr, Pb, Sb, and B, 0<x≤1.2, 0<y≤0.9, and 2.0≤z≤2.3). These may be used singly, or a plurality thereof may be mixed for use. In terms of achieving a higher capacity of the non-aqueous electrolyte secondary battery, the positive electrode active material preferably includes a lithium-nickel composite oxide such as LiₓNiO₂, LiₓCo_{y}Ni_{1-y}O₂, and LiₓNi_{1-y}M_{y}O_{z}(M represents at least one of the group consisting of Na, Mg, Sc, Y, Mn, Fe, Co, Ni, Cu, Zn, Al, Cr, Pb, Sb, and B, 0<x≤1.2, 0<y≤0.9, and 2.0≤z≤2.3).

Examples of the conductive agent included in the positive electrode mixture layer include carbon-based particles such as carbon black (CB), acetylene black (AB), Ketjenblack, carbon nanotube (CNT), graphene, and graphite. These may be used singly, or may be used in combinations of two or more thereof.

Examples of the binder included in the positive electrode mixture layer include fluororesins such as polytetrafluoroethylene (PTFE) and polyvinylidene fluoride (PVdF), polyacrylonitrile (PAN), a polyimide resin, an acrylic resin, and a polyolefin resin. These may be used singly, or may be used in combinations of two or more thereof.

The positive electrode core exposed portion is a portion where the surface of the positive electrode core is not covered with the positive electrode mixture layer, and preferably provided on both surfaces of the positive electrode 11 so as to be overlapped in the thickness direction of the positive electrode 11. The positive electrode core exposed portion is provided at, for example, a position with the substantially same distance from an inner end of winding and an outer end of winding of the electrode assembly 14 from the viewpoint of current collectability. Connecting the positive electrode lead 20 to the positive electrode core exposed portion provided at such a position allows the positive electrode lead 20 to be disposed with protruding upward at a substantial center in the diameter direction of the electrode assembly 14 from the end face in the axial direction when wound as the electrode assembly 14. The positive electrode core exposed portion is provided by, for example, intermittent application in which the positive electrode mixture slurry is not applied onto a part of the positive electrode core.

The negative electrode 12 has a negative electrode core 30, a negative electrode mixture layer 32 formed on at least a part of a surface of the negative electrode core 30, and a negative electrode core exposed portion 34 provided on an end on one side in the width direction. The negative electrode mixture layer 32 is formed on at least one of an inner peripheral side and an outer peripheral side of the negative electrode core 30, and preferably formed on an entire region of both surfaces of the negative electrode core 30 except for a negative electrode core exposed portion 34, described later. For the negative electrode core, a foil of a metal such as copper, a film in which such a metal is disposed on a surface layer thereof, and the like are used, for example. A thickness of the negative electrode core is, for example, greater than or equal to 5 μm and less than or equal to 30 μm.

The negative electrode mixture layer 32 includes, for example, a negative electrode active material and a binder. The negative electrode 12 may be produced by, for example, applying a negative electrode mixture slurry including the negative electrode active material, the binder, and a solvent such as water onto both surfaces of the negative electrode core 30, followed by drying and then rolling.

The negative electrode active material included in the negative electrode mixture layer 32 is not particularly limited as long as it can reversibly intercalate and deintercalate lithium ions. For example, carbon-based materials such as natural graphite and artificial graphite, metals that form an alloy with lithium, such as Si and Sn, an alloy and oxide including these materials, or the like may be used.

The negative electrode active material may include the carbon-based material and a silicon-based material. Examples of the silicon-base material include Si, an alloy including Si, and silicon oxide such as SiOₓ (x is greater than or equal to 0.8 and less than or equal to 1.6). The silicon-based material is a negative electrode active material that may further increase the battery capacity than the carbon-based material. A content rate of the silicon-based material in the negative electrode active material is preferably greater than or equal to 3 mass % relative to a mass of the negative electrode active material from the viewpoints of the increase in the battery capacity, inhibition of deterioration of charge-discharge cycle characteristics, and the like. An upper limit of the content rate of the silicon-based material is, for example, 20 mass %.

Examples of the binder included in the negative electrode mixture layer 32 include styrene-butadiene rubber (SBR), nitrile-butadiene rubber (NBR), carboxymethylcellulose (CMC) or a salt thereof, polyacrylic acid (PAA) or a salt thereof (which may be PAA-Na, PAA-K, and the like, or a partially neutralized salt), and polyvinyl alcohol (PVA). These may be used singly, or may be used in combinations of two or more thereof.

The negative electrode core exposed portion 34 is a portion where the surface of the negative electrode core 30 is not covered with the negative electrode mixture layer 32, and preferably provided on both surfaces of the negative electrode 12 so as to be overlapped in the thickness direction of the negative electrode 12.

As illustrated in FIG. 2, the negative electrode core exposed portion 34 is protruded from the end face on one side in the winding axis direction of the electrode assembly 14 immediately after the winding. That is, on the end on one side in the width direction (axial direction) of the negative electrode 12, the negative electrode core exposed portion 34 where the negative electrode core 30 is exposed is formed. On the end on a side on which the negative electrode core exposed portion 34 is formed, the negative electrode 12 is protruded from the end face of the electrode assembly 14 over the separator 13. The negative electrode core exposed portion 34 is formed along the winding direction with the substantially same width, and a boundary line between the negative electrode mixture layer 32 and the negative electrode core exposed portion 34 is preferably sandwiched with the separators 13.

For the separator 13, a porous sheet having an ion permeation property and an insulation property is used. Specific examples of the porous sheet include a fine porous thin film, a woven fabric, and a nonwoven fabric. As a material for the separator 13, a polyolefin resin such as polyethylene and polypropylene, cellulose, and the like are preferable. The separator 13 may have any of a single-layered structure and a multi-layered structure. On a surface of the separator 13, a heat-resistant layer and the like may be formed. A thickness of the separator is, for example, greater than or equal to 10 μm and less than or equal to 50 μm.

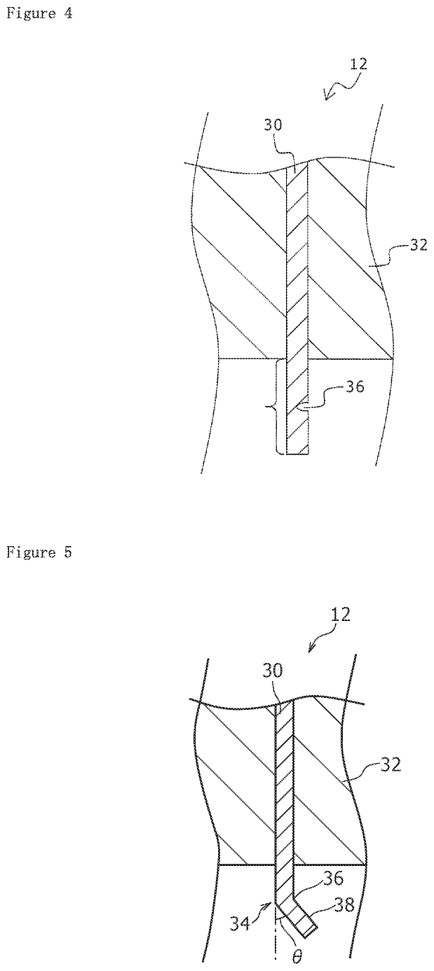

Next, a shape of the negative electrode core exposed portion 34 protruded from the electrode assembly 14 immediately after the winding will be described with reference to FIG. 3 to FIG. 5. FIG. 3 is a front view illustrating the negative electrode 12 to constitute the electrode assembly 14 in an unwound state in an example of an embodiment. FIG. 4 is a cross-sectional view along the A-A line in FIG. 3, and FIG. 5 is a view corresponding to FIG. 4 in the negative electrode 12 in the electrode assembly 14.

As illustrated in FIG. 3, the negative electrode core exposed portion 34 has an easily-deformable portion 36 formed along the winding direction of the electrode assembly 14. In the example illustrated in FIG. 3, the easily-deformable portion 36 is continuously formed. The easily-deformable portion 36 may be discontinuously formed like, for example, broken lines or dot lines. In the example illustrated in FIG. 3, the easily-deformable portion 36 is a straight line, but may have a curved portion as long as the negative electrode core 30 may be bent along the easily-deformable portion 36, described later.

In FIG. 3, a length of the negative electrode core exposed portion 34 in the axial direction is, for example, greater than or equal to 2 mm and less than or equal to 20 mm. A length of the end face portion 38 in the axial direction is substantially same as a length from the easily-deformable portion 36 to a tip of the negative electrode core exposed portion 34, and is, for example, greater than or equal to ⅓ and less than or equal to ⅔ of the length of the negative electrode core exposed portion 34 in the axial direction.

In the present embodiment, the easily-deformable portion 36 is a groove, as illustrated in FIG. 4. A depth of the groove is preferably greater than or equal to ⅕ and less than or equal to ⅔ of the thickness of the negative electrode core 30, and preferably greater than or equal to ⅓ and less than or equal to ½ of the thickness of the negative electrode core 30. A width of the groove is preferably greater than or equal to ½ and less than or equal to 3/2 of the depth of the groove, for example.

A cross-sectional shape of the negative electrode 12 changes from the shape illustrated in FIG. 4 to the shape illustrated in FIG. 5 by the winding to form the electrode assembly 14. In the electrode assembly 14 immediately after the winding, the negative electrode core exposed portion 34 has the end face portion 38 formed by bending along the easily-deformable portion 36. According to this, directions to which the end face portions 38 direct coincide with each other when the end face portion 38 is pressed against the current-collecting plate 40, and a gap between the end face portions 38 adjacent to each other in the radial direction of the electrode assembly 14 is not generated. Thus, when the current-collecting plate 40 is laser-bonded to the end face portion 38, reaching of the laser light through the gap between the end face portions 38 to an inside of the electrode assembly 14 may be prevented. Furthermore, flatness of the end face of the electrode assembly 14, which includes the end face portion 38 of the negative electrode core exposed portion 34, is improved, and thereby bonding strength between the end face portion 38 and the current-collecting plate 40 may be increased.

The end face portion 38 is preferably formed by bending the negative electrode core exposed portion 34 to the inner side along the easily-deformable portion 36 in the radial direction of the electrode assembly 14. According to this, the electrode assembly 14 is easily housed in the exterior can 16. When the easily-deformable portion 36 is the groove, the end face portion 38 is formed with inclination toward the face having the groove. In FIG. 5, an angle θ indicating the inclination of the end face portion 38 is greater than or equal to 5° and less than or equal to 90°, for example.

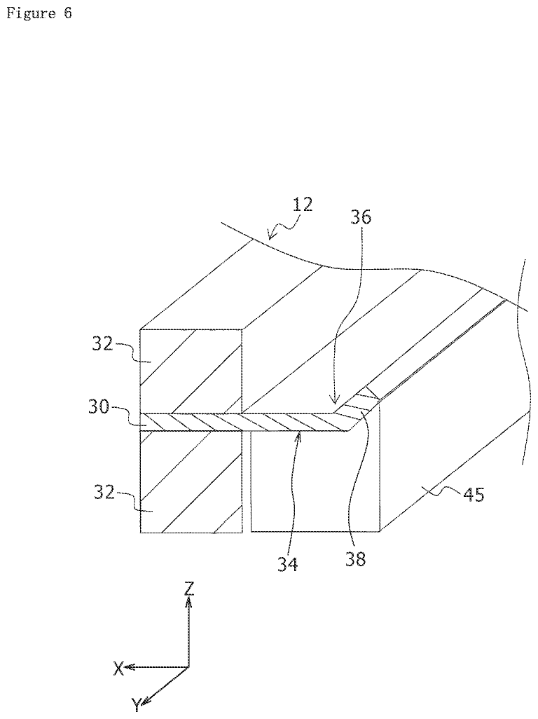

FIG. 6 is a view illustrating a step of forming the end face portion 38 by bending the negative electrode core exposed portion 34. The direction of the X-axis represents the axial direction of the electrode assembly 14, and the direction of the Y-axis represents the winding direction of the electrode assembly 14. The negative electrode 12 moves toward the “+” direction in the Y-axis relative to a guide rail 45. An inclining angle of a slope provided on an upper face of the guide rail 45 increases from the “−” direction toward the “+” direction of the Y-axis, and the angle becomes constant after reaching a predetermined value. The negative electrode core 30 is positioned on the guide rail 45, and deformed along a shape of the upper face of the guide rail 45 so as to be bent along the easily-deformable portion 36.

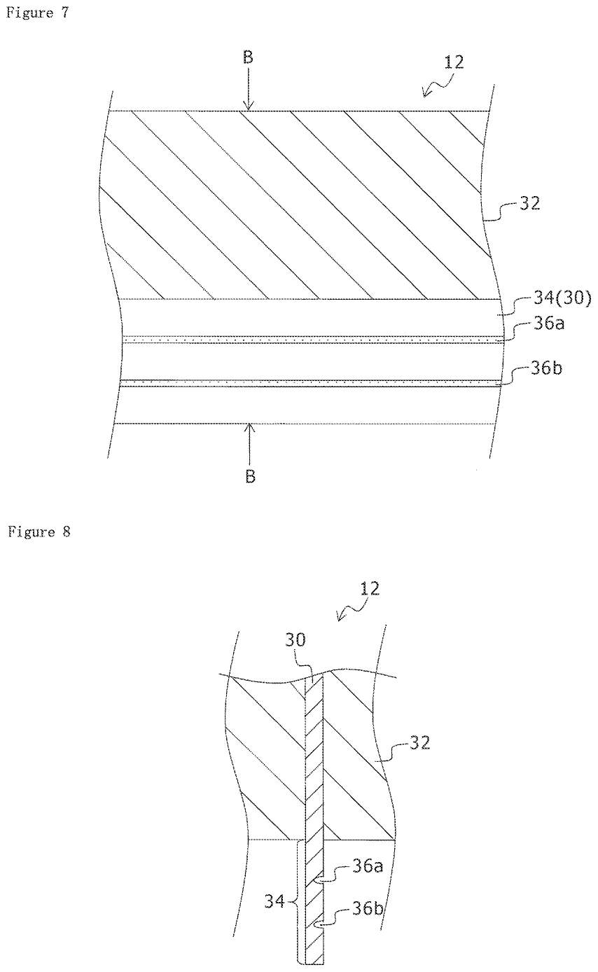

Next, an end face portion 138 in another example of the embodiment will be described with reference to FIG. 7 to FIG. 9. FIG. 7 is a front view illustrating the negative electrode 12 to constitute the electrode assembly 14 in an unwound state in another example of the embodiment. FIG. 8 is a cross-sectional view along the B-B line in FIG. 7, and FIG. 9 is a view corresponding to FIG. 8 in the negative electrode 12 in the electrode assembly 14.

As illustrated in FIG. 7, the negative electrode core exposed portion 34 has a first easily-deformable portion 36a and a second easily-deformable portion 36b that are formed along the winding direction of the electrode assembly 14. The first easily-deformable portion 36a and the second easily-deformable portion 36b may be continuous, or may be discontinuous. The first easily-deformable portion 36a and the second easily-deformable portion 36b are not limited to straight lines, and may include a curved line.

In FIG. 7, a length of the negative electrode core exposed portion 34 in the axial direction is, for example, greater than or equal to 3 mm and less than or equal to 30 mm. A length of the end face portion 138 in the axial direction is substantially same as a distance between the first easily-deformable portion 36a and the second easily-deformable portion 36b, and substantially same as a length from the second easily-deformable portion 36b to the tip of the negative electrode core exposed portion 34, and is, for example, greater than or equal to ⅕ and less than or equal to ½ of the length of the negative electrode core exposed portion 34 in the axial direction.

In the present embodiment, the first easily-deformable portion 36a and the second easily-deformable portion 36b are grooves, as illustrated in FIG. 8. A depth of the first easily-deformable portion 36a is, for example, substantially same as a depth of the second easily-deformable portion 36b. The depths of the first easily-deformable portion 36a and the second easily-deformable portion 36b are preferably greater than or equal to ⅕ and less than or equal to ⅔ of the thickness of the negative electrode core 30, and more preferably greater than or equal to ⅓ and less than or equal to ½ of the thickness of the negative electrode core 30. A width of the first easily-deformable portion 36a is, for example, substantially same as a width of the second easily-deformable portion 36b. The widths of the first easily-deformable portion 36a and the second easily-deformable portion 36b are preferably greater than or equal to ½ and less than or equal to 3/2 of the depth of the groove, for example.

The negative electrode 12 is formed from the cross-sectional shape illustrated in FIG. 8 to the cross-sectional shape illustrated in FIG. 9 by the winding to form the electrode assembly 14. The negative electrode core exposed portion 34 is folded along the second easily-deformable portion 36b to have the end face portion 138 formed by bending along the first easily-deformable portion 36a. Folding at the second easily-deformable portion 36b allows the end face portion 138 to be twice as thick as the negative electrode core 30, and may increase output of laser light irradiation with which the end face portion 138 is laser-bonded to the current-collecting plate 40.

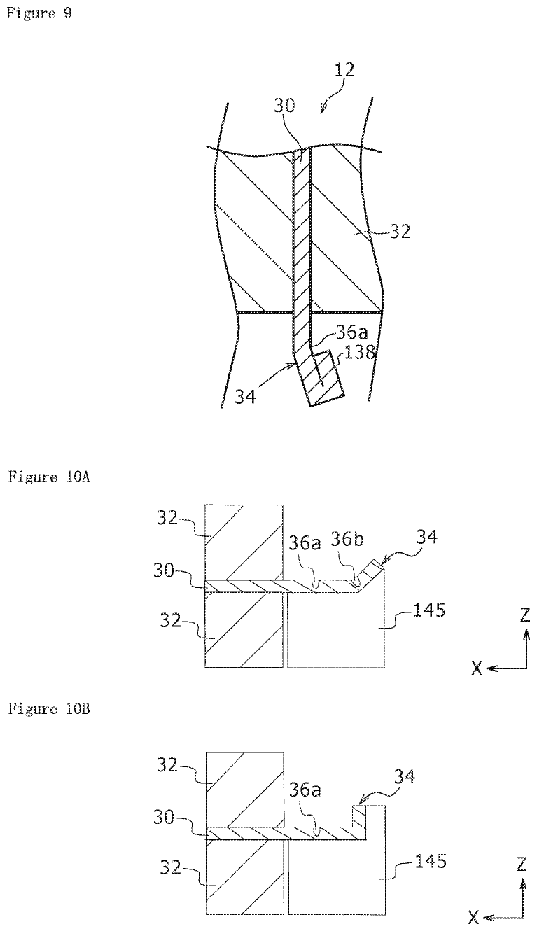

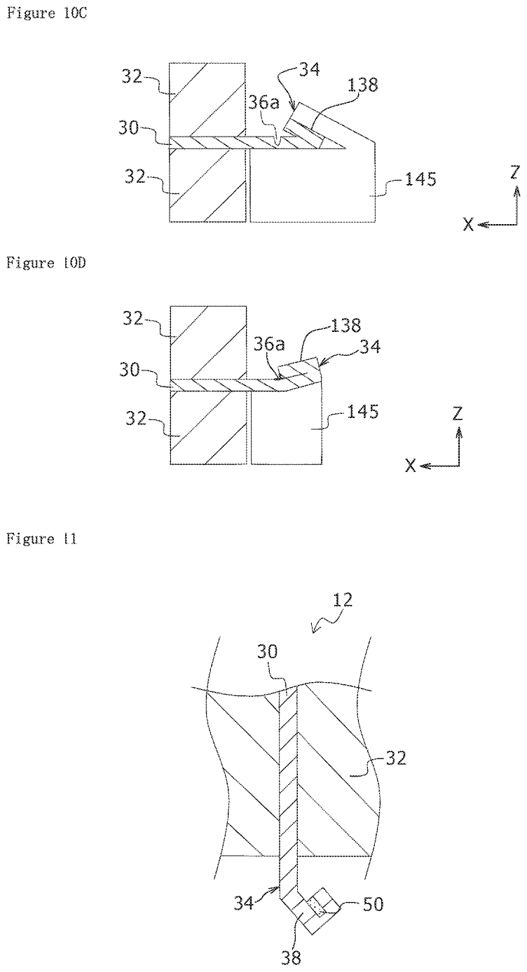

FIG. 10A to FIG. 10D are views illustrating an example of a step of forming the end face portion 138 by bending the negative electrode core exposed portion 34. First, as illustrated in FIG. 10A, the negative electrode core exposed portion 34 is bent along the second easily-deformable portion 36b. Furthermore, the negative electrode core exposed portion 34 is bent from a state in FIG. 10A via a state in FIG. 10B to a state in FIG. 10C to form the thick end face portion 138. Finally, the negative electrode core exposed portion 34 is bent along the first easily-deformable portion 36a from the state in FIG. 10C to incline the end face portion 138 as in FIG. 10D. A shape of a guide rail 145 sequentially changes in the Y-axis direction as illustrated in FIG. 10A to FIG. 10D.

FIG. 11 is a view illustrating the end face portion 138 in another example of the embodiment. The end face portion 138 in this example further includes an insertion plate 50 inside an end face portion 238 in FIG. 9. According to this, the end face portion 238 is greater than or equal to twice as thick as the negative electrode core 30, and may further increase output of laser light irradiation with which the end face portion 238 is laser-bonded to the current-collecting plate 40.

A material of the insertion plate 50 is, for example, metal. In the negative electrode 12, the material of the insertion plate 50 is preferably Ni from the viewpoint of welding ability with the negative electrode core 30. A thickness of the insertion plate 50 is preferably larger than a thickness of a core covering the insertion plate 50 from the viewpoint of operability. The thickness of the insertion plate 50 is, for example, greater than or equal to 10 μm and less than or equal to 50 μm. When the insertion plate 50 is used, the core may be bent along an end of the insertion plate 50, and thereby, in the negative electrode core exposed portion 34, a portion contacted with the end of the insertion plate 50 may be the easily-deformable portion 36. In this case, the groove as illustrated in FIG. 7 and FIG. 8 is unnecessary.

### EXAMPLES

Hereinafter, the present disclosure will be further described with Examples, but the present disclosure is not limited to these Examples.

### [Production of Positive Electrode]

A lithium-nickel composite oxide as a positive electrode active material, polyvinylidene fluoride as a binder, and acetylene black as a conductive agent were mixed, and an appropriate amount of N-methyl-2-pyrrolidone (NMP) was added to prepare a positive electrode mixture slurry. The positive electrode mixture slurry was applied onto both surfaces of a positive electrode core made of aluminum foil except for a connection portion of a positive electrode lead, and the resulting coating film was dried. The dried coating film was rolled to a predetermined thickness by using a roller, then cut to a predetermined size to produce a positive electrode, and a positive electrode lead made of aluminum was welded with the connection portion.

### [Production of Negative Electrode]

Copper foil with 8 μm in thickness was cut to a band shape, a linear groove with 4 μm in width and 4 μm in depth was formed by imprinting on one surface of the copper foil along the longitudinal direction to produce a negative electrode core. Easily-graphitizing carbon as a negative electrode active material, polyvinylidene fluoride as a binder, and carboxymethylcellulose as a thickener were mixed, and an appropriate amount of water was added to prepare a negative electrode mixture slurry. The negative electrode mixture slurry was applied onto both surfaces of the negative electrode core except for a portion corresponding to a negative electrode core exposed portion, and the resulting coating film was dried. The dried coating film was rolled to a predetermined thickness by using a roller, then cut to a predetermined size to produce a negative electrode. The produced negative electrode had the same constitution as the embodiment illustrated in FIG. 3. A length of the negative electrode core exposed portion in an axial direction was 4 mm, and a length from a lower end of the negative electrode mixture layer to the groove was 2 mm.

### [Production of Electrode Assembly]

So that the negative electrode core exposed portion (negative electrode core) was protruded from an end face on one side in a winding direction of an electrode assembly, the positive electrode and the negative electrode were wound via a separator made of a polyolefin resin to produce the electrode assembly. When wound, the electrode assembly was bent with approximately 300 on a guide rail from the groove to a tip of the negative electrode core exposed portion to form an end face portion with 2 mm in length. The negative electrode core had a shape similar to that of the example illustrated in FIG. 5.

[Laser-Bonding between End Face Portion and Current Collector]

As a current-collecting plate, nickel-plated carbon steel having a disk shape and a thickness of 0.4 mm was used. The end face on a side on which the negative electrode core of the electrode assembly was protruded was pressed against the current-collecting plate, and the end face was irradiated with laser light with linearly scanning from the current-collecting plate side to laser-bond the current-collecting plate and the end face portion. The laser-bonding was performed on the current-collecting plate at a total four positions in each 90-degree direction.

### [Evaluation of Damage of Electrode Assembly]

By using an X-ray CT apparatus (SMX-225CT FPD HR, manufactured by SHIMADZU CORPORATION), a cross section of the laser-bonded portion was observed. CT images were obtained at 12 positions so that an entirety of the welded portion may be observed. A case where a trace of combustion of the separator and the like was observed in any of the photographed positions was judged as presence of damage, and presence/absence of the damage was evaluated.

### Example 2

The damage of the electrode assembly was evaluated in the same manner as in Example 1 except that: in the production of the negative electrode, two linear grooves (4 μm in width and 4 μm in depth) were formed with a gap of 2 mm on a negative electrode core exposed portion having a length of 6 mm in the axial direction by imprinting with the same constitution as of the embodiment illustrated in FIG. 7; and in the production of the electrode assembly, the electrode assembly was bent with approximately 300 at the groove on the base side when being folded on the guide rail from the groove on the tip side to form a thick end face portion with 2 mm in length. The negative electrode core had a shape similar to that of the example illustrated in FIG. 9.

### Example 3

The damage of the electrode assembly was evaluated in the same manner as in Example 2 except that: in the production of the negative electrode, a metal plate made of Ni and having a width of 1.5 mm and a thickness of 30 μm was interposed between the two grooves; and in the production of the electrode assembly, the metal plate was covered with the negative electrode core when the electrode assembly was folded from the groove on the tip side on the guide rail. The negative electrode core had a shape similar to that of the example illustrated in FIG. 11.

Table 1 shows the evaluation results of Examples 1 to 3. Table 1 also shows the features of the negative electrode core of each Example.

TABLE 1

| | | Damage of |
|---|---|---|
| | | electrode |
| | Constitution of end face portion | assembly |
| Example 1 | Negative electrode core with single | absent |
| | layer (FIG. 5) | |
| Example 2 | Negative electrode core with double | absent |
| | layer (FIG. 9) | |
| Example 3 | Negative electrode core with double | absent |
| | layer and Ni plate (FIG. 11) | |

No damage of the electrode assembly was observed in all Examples. Therefore, it is understood that the damage of the electrode assembly may be inhibited by the end face portion formed by bending the negative electrode core exposed portion, which protruded from the end face on one side in the winding axis direction of the electrode assembly, along the easily-deformable portion formed along the winding direction of the electrode assembly.

### REFERENCE SIGNS LIST

10 secondary battery, 11 positive electrode, 12 negative electrode, 13 separator, 14 electrode assembly, 16 exterior can, 16a shoulder portion, 16b grooved portion, 16c side wall, 16d bottom, 17 sealing assembly, 18 insulating plate, 20 positive electrode lead, 23 terminal plate, 23a ventilation hole, 23b thin portion, 24 insulating plate, 24a ventilation hole, 27 rupture plate, 28 gasket, 30 negative electrode core, 32 negative electrode mixture layer, 34 negative electrode core exposed portion, 36 easily-deformable portion, 36a first easily-deformable portion, 36b second easily-deformable portion, 38, 138, 238 end face portion, 40 current-collecting plate, 45, 145 guide rail, 50 insertion plate

1. A non-aqueous electrolyte secondary battery, comprising:
an electrode assembly in which a first electrode and a second electrode having polarities different from each other are wound via a separator;
a non-aqueous electrolyte;
a bottomed-cylinder-shaped exterior can housing the electrode assembly and the non-aqueous electrolyte; and
a sealing assembly capping an opening of the exterior can, wherein
the first electrode has: a core; a mixture layer formed on at least a part of a surface of the core; and an exposed portion of the core provided on an end on one side in a winding axis direction of the electrode assembly,
the exposed portion has an easily-deformable portion formed along a winding direction of the electrode assembly,
on an end face on one side in the winding axis direction of the electrode assembly, an end face portion formed by bending the exposed portion along the easily-deformable portion is disposed,
the end face portion is bonded to a current-collecting plate, and
the current-collecting plate is connected to the exterior can or the sealing assembly.

2. The non-aqueous electrolyte secondary battery according to claim 1, wherein the exposed portion is bent to an inner side in a radial direction of the electrode assembly along the easily-deformable portion.

3. The non-aqueous electrolyte secondary battery according to claim 1, wherein the first electrode is a negative electrode.

4. The non-aqueous electrolyte secondary battery according to claim 1, wherein the easily-deformable portion is a groove.

5. The non-aqueous electrolyte secondary battery according to claim 4, wherein the groove is continuously formed.

6. The non-aqueous electrolyte secondary battery according to claim 4, wherein the groove is discontinuously formed.

7. A method for manufacturing a non-aqueous electrolyte secondary battery comprising: an electrode assembly in which a first electrode and a second electrode having polarities different from each other are wound via a separator; a non-aqueous electrolyte; a bottomed-cylinder-shaped exterior can housing the electrode assembly and the non-aqueous electrolyte; and a sealing assembly capping an opening of the exterior can, wherein
the first electrode has: a core; a mixture layer formed on at least a part of a surface of the core; and an exposed portion of the core provided on an end on one side in a winding axis direction of the electrode assembly, and
when the first electrode and the second electrode are wound, the exposed portion is protruded from one end face in a winding axis direction of the electrode assembly, the exposed portion is bent along an easily-deformable portion formed along a winding direction of the electrode assembly to dispose an end face portion formed by bending the exposed portion, and the end face portion and a current-collecting plate are laser-bonded.
